(19) United States
(12) Patent Application Publication
(10) Pub. No.: US 2024/0051176 A1
(43) Pub. Date: Feb. 15, 2024

(54) MACHINE TOOL FOR MACHINING A PIECE OF WOOD

(71) Applicant: EPUR, RODOME (FR)

(72) Inventors: Pierre GIUSTI, ESPEZEL (FR); Denis VINET, BELBEZE EN COMMINGES (FR); Olivier CLAIR, RODOME (FR)

(73) Assignee: EPUR, RODOME (FR)

(21) Appl. No.: 18/265,298

(22) PCT Filed: Dec. 3, 2021
(86) PCT No.: PCT/EP2021/084211

§ 371 Date: Jun. 5, 2023

(30) Foreign Application Priority Data
Dec. 4, 2020 (FR) FR2012662

(51) Int. Cl. B27C 9/02; B27C 5/06; B27M 1/08

(52) U.S. Cl. CPC B27C 9/02; B27C 5/06; B27M 1/08

(57) ABSTRACT

The invention relates to a machine tool for machining a piece of wood (10) comprising: a positioning module (100) comprising a frame (110) supporting a horizontal table (120) for receiving a piece of wood to be machined; a machining module (200) comprising a frame (210) arranged facing said frame (110) of said positioning module, a digitally-controlled portable machining device (260), a vertical chassis (230) mounted to be movable in translation and in rotation with respect to the frame (210) of said machining module and means for detachably fixing said portable machining device (260) on said movable chassis (230).

### TECHNICAL FIELD OF THE INVENTION

The field of the invention is that of the digital machining of pieces of wood, in particular that of machine tools for machining pieces of wood.

### TECHNOLOGICAL BACKGROUND

There are principally three large families of machine tools used for machining a piece of wood.

The first family is formed by the manual devices each equipped with a specific tool, such as a saw, a plane, etc. and which are handled directly by an operator in order to machine the piece of wood. In other words, it is the operator who moves the machining tool with respect to the piece to be machined and who exerts the force enabling the wood to be cut.

This family of devices has the advantage that it can be used to machine the pieces of wood directly at the site where the piece will be used. On the other hand, these devices have the disadvantage of forcing the operator to handle the machining tool directly, which can cause injuries. Furthermore, the machining is less precise than with a digitally-controlled machine. Finally, it is up to the operator to exert the machining force, possibly assisted by an electric motor where portable manually-operated electric devices are concerned, which can be physically exhausting.

The second family is formed by the digitally-controlled machining devices which each comprise a chassis which rests on the floor of the machining site, a cutting tool mounted on the chassis, means for automatically driving the cutting tool and means for receiving the piece of wood to be machined. The cutting tool may be of various types. It may be e.g. a milling machine for wood, a circular saw, a plane, etc.

The machining devices of this family have the disadvantage of being relatively bulky and of necessitating the movement of the piece of wood towards the machining device. The piece of wood, once machined, can then be moved towards the site where it is to be installed, e.g. a framework. Furthermore, these are often expensive machines beyond the reach of carpenters unless they have a large volume of business so as to justify the investment.

On the other hand, these machining devices have the advantage of enabling precise machining to be carried out, limiting injuries in that the tool is not handled directly by the operator, and finally limiting fatigue in that the cutting tool is driven directly by a motor which is generally an electric motor, and no longer by the manual strength of the operator.

The third family, newly proposed by the applicant, is formed by portable machining devices such as those described in the patents FR3050135, FR2000758 and FR2008556. This family is thus that of portable devices for automated machining of a piece of wood. These tools thus have the feature of enabling use of a digitally-controlled machining means directly at the location of final installation of the piece of wood. These devices may also enable the carpenter to move more freely about his workshop. In other words, these are devices which are moved towards the piece to be machined and not the reverse scenario.

It will thus be noted that, depending on the work site and the intended machining, it is necessary to use a machine from one of the above-mentioned families or another. A carpenter thus needs to have all of these machines in his workshop, which imposes the double disadvantage of requiring a considerable budget to purchase equipment and of having corresponding space to store the various machines required.

The applicant has thus sought to propose a novel solution making it possible to at least partially combine the advantages of the various existing solutions. In particular, the applicant has sought to propose a solution which makes it possible, in at least one embodiment of the invention, to combine the advantages of the portable device and the stationary machine tool.

### Aims of the Invention

The invention thus aims to provide a machine tool for machining a piece of wood, which overcomes at least some of the disadvantages of the known machine tools.

The invention also aims in particular to provide, in at least one embodiment of the invention, a versatile, multi-purpose machine tool for use in machining.

The invention aims in particular to provide, in at least one embodiment of the invention, a machine tool which makes it possible to combine the advantages of the stationary machine and of the portable machine.

In other words, the invention aims to provide, in at least one embodiment of the invention, a 2-in-1 type machine tool which can, as required, be used as a stationary machine tool or as a portable machine tool.

The invention also aims to provide, in at least one embodiment of the invention, a machine tool which can ensure the safety of the operator using such a machine tool.

The invention also aims to provide, in at least one embodiment of the invention, a machine tool which makes it possible to machine a piece of wood at a wide range of angles of cut, in particular between 0 to 180°.

### DESCRIPTION OF THE INVENTION

These aims and others which will become clear hereinunder are achieved with the aid of a machine tool for machining a piece of wood, comprising:
a first module, referred to as the positioning module, comprising a frame supporting a horizontal table for receiving a piece of wood to be machined, referred to as the positioning table, which extends in a direction, referred to as the longitudinal direction, and configured to be able to at least partially support said piece of wood,
a second module, referred to as the machining module, comprising:
   a frame arranged longitudinally facing said frame of said positioning module,
   a digitally-controlled portable machining device comprising a machining head fitted with a machining tool and means for moving said machining head on at least one horizontal axis and a vertical axis, referred to as the movement axes,
   a vertical chassis mounted to be movable with respect to said frame in translation on an axis parallel to said horizontal movement axis, and in rotation with respect to a vertical axis,
   means for detachable fixing of said portable machining device on said movable chassis.

A machine tool for use in machining in accordance with the invention thus comprises two sub-assemblies which cooperate with each other: a positioning module principally intended to position the piece of wood in order for it to be machined, and a machining module principally intended to carry out the machining itself.

The machining module bears the machining device fitted with the machining tool and has the feature of being able not only to move the machining tool in the horizontal direction and the vertical direction, but also of being able to move the machining device itself in the horizontal direction of movement of the machining tool (translation of the chassis), which makes it possible to increase the machining length in this direction with respect to the movement of the machining tool within the machining device, and of being able to move the machining device in rotation about a vertical axis (rotation of the chassis), which makes it possible to define the angle of cut of the piece of wood to be machined, but without moving the piece of wood to be machined.

The movements in translation and in rotation can be brought about by motorised means such as electric motors. These motorised means can be associated with means for fixing the position of the chassis during the machining operation. The motorised means can also comprise predetermined indexed positions enabling an operator to rapidly position the machining device borne by the chassis at specific positions (e.g. every 10 cm for the translation or every 10 degrees for the rotation).

The chassis is preferably movable in translation with respect to a rail which is itself movable in rotation with respect to the frame. It is thus possible to firstly adjust the angle of cut (by rotation of the chassis and of the rail with respect to the frame) and then to adjust the position of the cut (by the translation of the machining device along the rail forming an intermediate structure between the chassis and the frame).

The machine tool for use in machining in accordance with the invention also makes it possible, by reason of the possibility of increasing the movement of the machining tool on the horizontal movement axis (by translation of the chassis on an axis parallel to this movement axis), to machine cuts having large angles in a number of stages.

Furthermore and in accordance with the invention, the portable machining device is mounted on the vertical chassis by detachable fixing means.

The portable machining device (also designated by the terminology of machining robot throughout the text) comprises a machining head bearing a machining tool, means for moving said machining head on at least two axes perpendicular to each other and a digital control unit configured to be able to control said means for moving said machining head. Such a device is e.g. formed from the machining device described in the patent FR2000758 in the name of the applicant.

The machining device is portable and can be carried manually by a single operator.

A machine tool in accordance with the invention is thus remarkable in that it makes it possible to use the machine tool as a stationary machine tool (in the case where the portable machining device is mounted on the chassis) or as a portable machine tool (in the case where the portable machining device is separated from the chassis in order to be carried by an operator for stand-alone use). A machine tool in accordance with the invention thus makes it possible to combine the advantages of the stationary machine tool and of the portable machine according to need. The elements of the machine tool in accordance with the invention without the machining device thus form an accessory of the machining device which makes it possible to convert it into a stationary machine tool.

Advantageously and in accordance with the invention, said machining module further comprises a horizontal table able to move in rotation conjointly with said chassis with respect to said vertical axis, referred to as the machining table, which extends in a plane which substantially coincides with the plane in which said positioning table extends so that said piece of wood can rest on said machining table and on said positioning table at the same time.

According to this aspect of the invention, the machining table rotates conjointly with the chassis with respect to said vertical axis. This machining table can e.g. be in the form of a semi-circle, the machining tool being substantially in line with the centre of the semi-circle. Thus the end of the piece of wood can be supported by the machining table irrespective of the rotation of the chassis bearing the machining device.

According to this embodiment variant, the machining table can comprise a visual scale of the angle of rotation (or a digital display connected to a digital encoder) of the table with respect to an origin, which is e.g. formed by the longitudinal direction. Such a visual scale (or digital display) enables the operator to see the angle of rotation of the machining device and thus the angle of cut of the piece of wood to be machined.

Advantageously and in accordance with the invention, said means for detachable fixing of said portable machining device on said vertical chassis comprise:
a peripheral shoulder provided on said vertical chassis matching the periphery of the machining device so as to form a housing to receive said machining device,
pivoting locking latches mounted on said peripheral shoulder and configured to be able to move from a first position in which the machining device can be freely inserted in said receiving housing formed by said peripheral shoulder to a second position in which the pivoting locking latches are pivoted and are inserted into matching orifices provided in the machining device in order to ensure that said machining device is held against the peripheral shoulder of said chassis which prevents the dislodgement of said machining device.

A machine tool according to this advantageous variant makes it easier to fixedly attach the portable machining device and the chassis of the machining module together and to separate them. In particular, an operator can mount and fix the portable machining device on the chassis without external assistance. In particular, the machining device is portable, in particular hand-carried, i.e. it can be carried by hand by an operator. This operator can thus grasp it, install it on the vertical chassis and operate the pivoting locking latches in order to form a stationary machine tool for use in machining. Nevertheless, there is nothing to prevent the provision of a handling trolley in order to facilitate the movement of the portable machining device towards the vertical chassis of the machine tool. According to another variant, the pivoting latches can be mounted on the machining device and cooperate with matching orifices provided in the peripheral shoulder of said vertical chassis.

Advantageously and in accordance with the invention, the machine tool further comprises:
at least one optical sensor borne by said chassis of said machining module and configured to detect the presence of said piece of wood to be machined in a predetermined zone, referred to as the machining zone, in which said machining device can machine said piece of wood,
at least one indicating light configured to be switched on and visible to an operator when said optical sensor detects the presence of said piece of wood in said machining zone.

This advantageous variant makes it possible to detect the presence of the piece of wood in a machining zone and to signal this presence to an operator. The combination of the sensor and the indicating light forms means for pre-positioning of the piece of wood, e.g. to within 10 cm. An operator can thus adjust the piece of wood and move it towards the machining module until the indicating light switches on, meaning that the piece of wood has been detected in the proximity of the machining head. This switching-on of the light is subject to the detection of the presence of the piece of wood in the machining zone. The light is thus controlled directly or indirectly by the sensor for sensing the presence of the piece of wood in the machining zone. This is particularly useful for pieces of wood of very large dimensions. As a variant, the indicating light can be replaced and/or combined with an audible signal.

Advantageously and in accordance with the invention, said positioning module comprises means for moving said positioning table with respect to the frame in said longitudinal direction so as to be able to move said beam supported by said positioning table towards said machining head borne by said vertical chassis of said machining module.

According to this advantageous variant, it is possible to move the positioning table supporting the piece of wood to be machined forwards towards the machining device, or backwards, in order to prepare for machining. This movement results from the actuation of the movement means, which are preferably motorised.

The actuation of the means for moving the positioning table thus makes it possible to precisely position the piece of wood for machining. Thus, an operator preferably pre-positions the piece of wood in the proximity of the machining zone (by the combined use of the detection sensor and of the indicating light described above), then finalises the positioning by actuating the motorised means for moving the positioning table.

In order to facilitate this precise positioning of the piece of wood, the positioning module advantageously comprises a longitudinal guide fixedly attached to said frame and which extends laterally along said positioning table so as to be able to guide said piece of wood during the movement of said positioning table supporting said piece of wood to be machined. As a variant, the longitudinal guide is fixedly attached to the positioning table and not to the frame. According to this variant, the guide forms a stop for positioning the piece of wood on the table, the assembly formed by the guide and the table thus moving together towards the machining device.

Once more in order to facilitate this precise positioning of the piece of wood, the positioning module can also comprise means for fixedly attaching said piece of wood to be machined on said positioning table of said positioning module.

These means for providing fixed attachment are e.g. clamping means of the mechanical press type or any equivalent means. The clamping means ensure that the piece of wood will not slip on the table so that the movement of the piece of wood will exactly follow the movement of the positioning table.

Advantageously, a machine tool in accordance with the invention further comprises at least one laser mounted on the chassis and oriented towards said machining table so as to be able to project a reference line on the piece of wood partially supported by said machining table so that an operator can actuate the means for moving said positioning table partially supporting said piece of wood to be machined so that this reference line coincides with a reference mark marked by an operator on said piece of wood to be machined.

This advantageous variant facilitates the precise positioning of the piece of wood facing the machining tool. In particular, the combination of the means for moving the positioning table (which are preferably motorised) and of the laser for projecting a reference line makes it possible to know precisely the position of the piece of wood with respect to the machining tool (of which the position with respect to the laser is known).

Advantageously and in accordance with the invention, the machine tool further comprises a machining guard mounted to be movable in vertical translation on said vertical chassis of said machining module between a retracted position in which said guard extends above said machining zone and a guarding position in which said guard at least partially covers the machining zone.

This advantageous variant makes it possible to cover the machining zone so that the operator does not risk being in direct contact with the machining tool during machining of the piece of wood. This guard is mounted in vertical translation on said chassis in order to be able to be moved from the retracted position which leaves the machining zone free so that the operator can position the piece of wood to be machined in the machining position in which the guard covers the machining device and the machining zone.

Advantageously and in accordance with this variant, the machining guard comprises a plurality of vertical strips which can move freely in vertical translation and are configured to be able to fit closely to the shape of a part of said piece to be machined in the proximity of said machining zone when said machining guard is in said machining position.

According to this advantageous variant, the guard is formed of a plurality of strips which are free in moving in the vertical direction so that during movement of the guard from the retracted position to the guarding position the strips come into contact with the piece of wood to be machined or the periphery thereof and move freely in the direction opposite to the movement of the guard. This permits the strips to fit closely to the shape of the portion of the piece of wood to be machined. Such a guard has a functionality similar to that of contour gauge duplicators.

Advantageously and in accordance with this variant, said guard further comprises a lever for mechanically assisting the movement of the guard between the retracted position and the guarding position.

This makes it possible to facilitate the movement of the guard from the retracted position to the guarding position and vice versa.

The invention also relates to a machine tool characterised in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic perspective view of a machine tool in accordance with one embodiment of the invention in which the machining device is mounted on the chassis of the machining module,

FIG. 2 is a schematic perspective view of a machine tool in accordance with one embodiment of the invention in which the machining device is separated from the chassis of the machining module,

FIG. 3 is a schematic perspective view of the machine tool in accordance with one embodiment of the invention in which the guarding device is in the guarding position,

FIG. 4 is a schematic perspective view of the machining robot of a machine tool in accordance with one embodiment of the invention,

FIG. 5 is a schematic perspective partial view of the chassis for receiving the machining robot of the machining module.

### DETAILED DESCRIPTION OF AN EMBODIMENT OF THE INVENTION

In the figures, for the sake of illustration and clarity, scales and proportions have not been strictly respected. Throughout the detailed description which follows with reference to the figures, unless stated to the contrary, each element of the machine tool is described as it is arranged when the machine tool of which it forms part is ready to machine a piece of wood. This configuration is illustrated in particular in FIG. 1. Identical, similar or analogous elements are designated by the same reference signs in all the figures.

FIG. 1 schematically illustrates a machine tool for machining a piece of wood 10 according to one embodiment of the invention.

The machine tool in accordance with the invention comprises two modules which cooperate with each other: a positioning module 100 and a machining module 200.

The positioning module 100 comprises a frame 110 supporting a horizontal positioning table 120 for receiving the piece of wood 10. This positioning table 120 extends in a longitudinal direction L.

The positioning module 100 also comprises motorised means for moving the positioning table 120 with respect to the frame 110. These motorised means are formed e.g. of an electric motor which drives a rack fixedly attached to the positioning table 120. Of course, other motorised means can be used to achieve the movement of the positioning table 120 with respect to the frame 110.

The positioning module 100 also comprises a longitudinal guide 130 fixedly attached to the frame 110. This guide is mounted on a lateral edge of the positioning table 120 e.g. by screwing or any equivalent means. This longitudinal guide 130 enables the piece of wood 10 to be guided during the movement of the positioning table 120 with respect to the frame. According to another variant, the guide can be fixedly attached to the positioning table 120 and accompany the movement of the piece of wood. In this case, the guide 130 forms a stop, against which the operator positions the piece of wood before machining.

The positioning module 100 preferably also comprises a mechanical press which acts as a means for fixedly attaching the piece of wood 10 on said positioning table 120.

The machining module 200 comprises a frame 210 which supports a vertical chassis 230 mounted to be movable with respect to the frame 210, both in rotation and in translation.

In order to do this, the machining module comprises e.g. a circular framework having a ball-bearing race 250 to which a rail bearing said chassis 230 is fixed. According to another embodiment, the circular framework comprises a circular groove 250 in which sliding shoes mechanically connected to the rail bearing said chassis 230 can slide.

The rail makes it possible to move the chassis in translation and the circular framework makes it possible to move the rail in rotation. Each of the movements (rotation or translation) can be effected by an electric motor controlled by an operator. Other means can be used to effect the rotational and/or translational movements of the chassis 230 with respect to the frame 210.

The machining module 200 also comprises a horizontal table fixedly attached to the circular framework, referred to as the machining table 220, which extends in a plane which substantially coincides with the plane in which the positioning table 120 extends. Thus the machining table 220 pivots with the chassis 230 which bears the machining robot 260 (described below), and the piece of wood 10 rests on the positioning table 120 and on the machining table 220 at the same time, while keeping the machining robot in line with the end of the piece of wood to be machined.

The machining module 200 further comprises a portable, digitally-controlled machining device 260 (also referred to by the terminology of machining robot). This machining robot 260 is e.g. the device described in the application FR2000758 in the name of the applicant and comprising a machining head fitted with a machining tool and means for moving the machining head on at least one horizontal axis and a vertical axis.

This device is portable, which means that it can be moved by an operator just using his own strength. The device in accordance with the embodiment of the figures has a weight of the order of 35 Kg and an overall size of 620 mm on the X axis, 450 mm on the Y axis and 655 mm on the Z axis, the X and Y axes defining the horizontal plane and the Z axis defining the vertical.

In FIG. 1, the machining device 260 is mounted on the chassis 230 so that the machine tool can form a stationary machine tool.

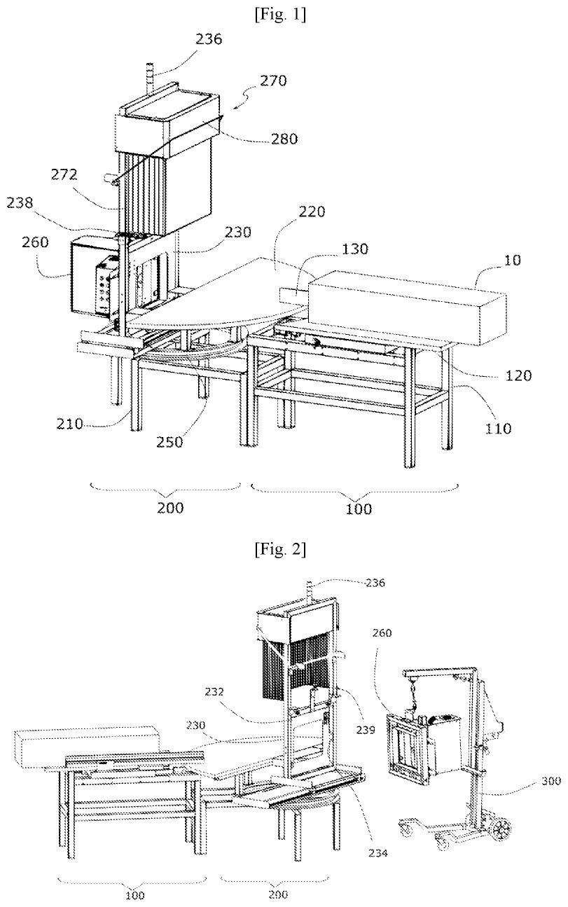

In FIG. 2, the machining device 260 is separated from the chassis 230 so that the machining device 260 can be used in a stand-alone manner without the chassis 230 and without the positioning module 100. According to the embodiment of FIG. 2, the machining device 260 is borne by a handling trolley 300 in order to facilitate the movement of the machining device 260 to another usage location. This handling trolley 300 comprises a base mounted on wheels, a bracket borne by the base and a hook borne by the bracket. The hook is matched with a catch provided on the machining device 260 in order to be able to grasp the machining robot when it is separated from the chassis 230 of the machine tool in accordance with the invention. Nevertheless, it should be noted that the use of the trolley is not indispensable in that the device is portable and can be moved manually by an operator, without any external assistance.

The machining device 260 of a machine tool according to the embodiment of the figures comprises, as shown in FIG. 4, a box 261 housing a machining head. The box 261 is e.g. formed of sheet metal. The machining head comprises e.g. a tool holder configured to be able to receive a machining tool 262 such as a router. The machining head is mounted to be movable with respect to the box and inside same, e.g. by means of ball-bearing runners and any equivalent means, not shown in the figures. The movement of the machining head on each axis is effected e.g. by a stepping motor configured to cause an endless screw to turn.

The machining device 260 further comprises a digital control unit, not shown in the figures, and configured to be able to control the motors for moving the machining head. This control unit is e.g. controlled by a remote control device with a touch screen intended to be operated by the operator controlling the machining of the piece of wood by the machine tool in accordance with the invention.

Finally, the machining device 260 comprises an interface plate 263 bolted to the box by fins which extend on both sides of the box. This plate is configured to come to be housed in a receiving housing provided in the chassis 230.

The chassis 230 comprises a generally rectangular framework 232 shown in particular in FIG. 2. It further has a peripheral shoulder 234 which defines the housing for receiving the interface plate 263 of the machining device 260. In other words, the receiving housing defined by the peripheral shoulder 234 is matched to the interface plate of the machining device 260.

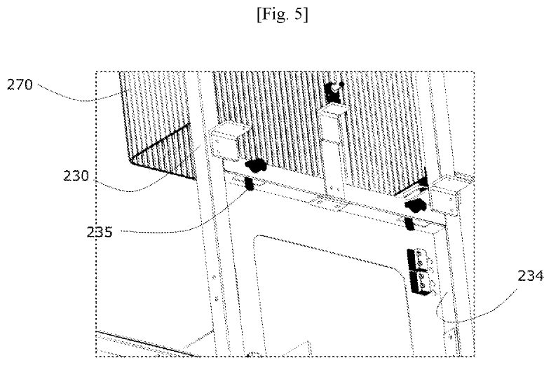

Once the plate of the portable machining device is housed in the receiving housing of the chassis 230 an operator can actuate pivoting locking latches 235, shown in particular in FIG. 5. These pivoting locking latches 235 are mounted on the chassis and are configured to permit movement from a first position in which the machining device 260 can be freely inserted into the receiving housing of the chassis 230 to a second position in which the pivoting locking latches are pivoted and are inserted into orifices provided in the interface plate 263 of the machining device. This makes it possible to fixedly attach the machining device 260 and the chassis 230 together and to prevent the dislodgement of the machining device 260. In combination, mechanical means for embedding the lower part of the plate into the shoulder 234 can be provided to assist in holding the machining module in the clasping module. These mechanical embedding means are formed e.g. by the lugs 265 shown in FIG. 4.

The machining module 200 further comprises a machining guard 270 (shown partially in FIG. 5 and in FIGS. 1, 2 and 3) mounted to be movable in vertical translation on the vertical chassis 230 between a retracted position in which said guard extends above the machining zone and a guarding position in which the guard at least partially covers the machining zone. The guard is mounted e.g. in a sliding manner on the chassis 230 in order to move from the retracted position to the machining position.

The machining guard 270 is formed e.g. from a plurality of vertical strips 272 which can move freely in vertical translation and are configured to be able to fit closely to the shape of the part of said piece of wood 10 to be machined in the proximity of the machining zone.

The machining guard 270 preferably further comprises a lever 280 for mechanically assisting the movement of the guard between the retracted position and the guarding position.

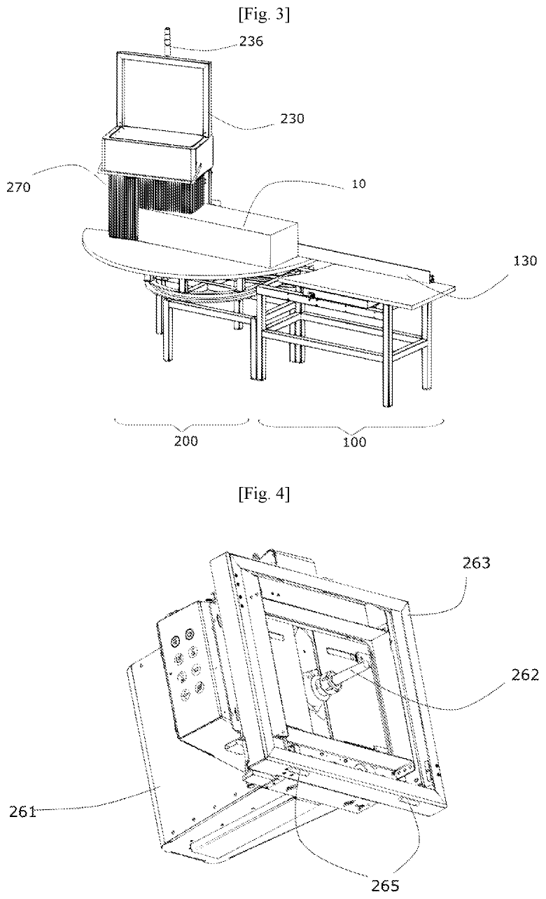

FIG. 3 illustrates the guard 270 in the guarding position. It will be noted that the guard 270 covers the piece of wood 10 to be machined at the machining zone.

The machine tool according to the embodiment of the figures also comprises an optical sensor borne by the chassis and configured to detect the presence of the piece of wood to be machined in a predetermined machining zone. This sensor can be of any known type such as a presence sensor. This sensor is connected to an indicating light 236 configured to be switched on and visible to an operator when the optical sensor detects the presence of the piece of wood 10 in said machining zone. This facilitates the positioning of the piece by the operator.

The combination of the sensor and the indicating light forms means for pre-positioning of the piece of wood, e.g. to within 10 cm. An operator can thus handle the piece of wood and move it towards the machining module until the indicating light switches on, showing that the piece of wood has been detected in the proximity of the machining head.

The precise positioning of the piece of wood can then consist of aligning a reference mark previously marked on the piece of wood to be machined with a marker from a laser mounted on the machine tool and oriented towards the machining table.

For example, and as shown in FIG. 1, a laser 238 can be mounted on the chassis 230 and controlled in order to project a reference line towards the machining table on the longitudinal direction axis. This facilitates the positioning of the piece for machining at the end of the piece. The laser 238 can, according to one variant, be mounted on a rail so as to adapt the projection of the light marker to the length of the machining tool mounted on the machining device.

As a variant or in combination, and as shown in FIG. 2, another laser 239 can be mounted on the chassis and oriented so as to be able to project a reference line towards the machining table and perpendicular to the longitudinal direction. This facilitates the positioning of the piece to be machined on the machining axis.

The lasers 238, 239 project the beam onto the machining table and the motorised movement of the positioning table 100 makes it possible to precisely align the piece to be machined which bears a reference mark previously marked by an operator, with this mark projected by the lasers.

The invention is not limited only to the embodiment described in connection with the figures. In particular, according to other embodiments, the machine tool can comprise other means for detachable connection between the machining robot and the vertical chassis for receiving the machining robot. The machine tool can also comprise other movement means for moving the positioning table or means for moving, in rotation and/or translation, the vertical chassis for receiving the machining robot which are different to those described in connection with the figures.

1. A machine tool for machining a piece of wood comprising:
a first module, referred to as the positioning module, comprising a frame supporting a horizontal table for receiving a piece of wood to be machined, referred to as the positioning table, which extends in a direction, referred to as the longitudinal direction, and configured to be able to at least partially support said piece of wood,
a second module, referred to as the machining module, comprising:
a frame arranged longitudinally facing said frame of said positioning module,
a digitally-controlled portable machining device comprising a machining head fitted with a machining tool and means for moving said machining head on at least one horizontal axis and a vertical axis, referred to as the movement axes,
a vertical chassis mounted to be movable with respect to said frame in translation on an axis parallel to said horizontal movement axis, and in rotation with respect to a vertical axis,
means for detachable fixing of said portable machining device on said movable vertical chassis.

2. The machine tool for use in machining as claimed in claim 1, wherein said machining module further comprises a horizontal table able to move in rotation conjointly with said chassis with respect to said vertical axis, referred to as the machining table, which extends in a plane which substantially coincides with the plane in which said positioning table extends so that said piece of wood can rest on said machining table and on said positioning table at the same time.

3. The machine tool for use in machining as claimed in any one of claim 1 or 2, wherein said means for detachable fixing of said portable machining device on said movable comprises:
a peripheral shoulder provided on said movable chassis and matched to the periphery of the machining device to define a housing for receiving said machining device,
pivoting locking latches mounted on said peripheral shoulder and configured to be able to move from a first position in which the machining device can be freely inserted in said receiving housing formed by said peripheral shoulder to a second position in which the pivoting locking latches are pivoted and are inserted into matching orifices provided in said machining device in order to ensure that said machining device is held against the peripheral shoulder of said chassis which prevents the dislodgement of said machining device.

4. The machine tool for use in machining as claimed in claim 1, wherein said positioning module further comprises means form moving said positioning table with respect to the frame in said longitudinal direction so as to be able to move said piece of wood supported by said positioning table towards said machining head of said machining module.

5. The machine tool for use in machining as claimed in claim 4, wherein said means for moving said positioning table in said longitudinal direction is motorised.

6. The machine tool for use in machining as claimed in claim 4, wherein said positioning module further comprises a longitudinal guide fixedly attached to said frame which extends laterally along said positioning table so as to be able to guide said piece of wood during movement of said positioning table supporting said piece of wood to be machined.

7. The machine tool for use in machining as claimed in claim 4, wherein the tool it further comprises at least one laser mounted on the chassis and oriented towards said machining table so as to be able to project a reference line on the piece of wood partially supported by said machining table so that an operator can actuate the means for moving said positioning table partially supporting said piece of wood to be machined so that this reference line coincides with a reference mark marked by an operator on said piece of wood to be machined.

8. The machine tool for use in machining as claimed in claim 1, wherein the tool it further comprises means for fixedly attaching said piece of wood to be machined on said positioning table of said positioning module.

9. The machine tool for use in machining as claimed in claim 1, wherein the tool it further comprises:
at least one optical sensor borne by said chassis of said machining module and configured to detect the presence of said piece of wood to be machined in a predetermined zone, referred to as the machining zone, in which said machining device can machine said piece of wood,
at least one indicating light configured to be switched on and visible to an operator when said optical sensor detects the presence of said piece of wood in said machining zone.

10. The machine tool for use in machining as claimed in claim 9, wherein the tool it further comprises a machining guard mounted to be movable in vertical translation on said vertical chassis of said machining module between a retracted position in which said guard extends above said machining zone and a guarding position in which said guard at least partially covers the machining zone.

11. The machine tool for use in machining as claimed in claim 10, wherein said machining guard comprises a plurality of vertical strips which can move freely in vertical translation and are configured to be able to fit closely to the shape of a part of said piece of wood to be machined in the proximity of said machining zone when said machining guard is in said machining position.

12. The machine tool for use in machining as claimed in claim 10, wherein said machining guard further comprises a lever for mechanically assisting the movement of the guard between the retracted position and the guarding position.
